(19) United States
(12) Patent Application Publication
(10) Pub. No.: US 2013/0223832 A1
(43) Pub. Date: Aug. 29, 2013

(54) SYSTEM AND METHOD FOR CONTROLLING SCATTERED LIGHT IN A REFLECTIVE OPTICAL FILTER

(71) Applicant: Lockheed Martin Corporation, (US)

(72) Inventor: Edward Jozef Miesak, Windermere, FL (US)

(73) Assignee: Lockheed Martin Corporation, Bethesda, MD (US)

(21) Appl. No.: 13/776,219

(22) Filed: Feb. 25, 2013

Related U.S. Application Data
(60) Provisional application No. 61/602,956, filed on Feb. 24, 2012.
(60) Provisional application No. 61/606,898, filed on Mar. 5, 2012.

(51) Int. Cl. F21V 13/08; G03B 15/03

(52) U.S. Cl. CPC F21V 13/08; G03B 15/03
USPC 396/200; 362/343; 362/293

(57) ABSTRACT

A system including a housing configured to receive a light emitted from an illumination source, a reflective filter system within the housing configured to direct a certain wavelength of the light emitted from the illumination source towards a target, and a baffle system configured to remove scattered light from the light emitted from the illumination source prior to the certain wavelength of light illuminating the target. A method and another system are also disclosed.

### CROSS-REFERENCE TO RELATED APPLICATIONS

This application claims the benefit of U.S. Provisional Application No. 61/602,956 filed Feb. 24, 2012, and U.S. Provisional Application No. 61/606,898 filed Mar. 5, 2012, and incorporated herein by reference in their entirety.

### BACKGROUND

Embodiments relate to an illumination system and, more particularly, filtering out scattered light so that a desired wavelength of light is made available.

Currently, when seeking to identify latent forensics evidence, such as, but not limited to, material comprising a fingerprint, standard forensic techniques include using dusting, super-glue fuming, and/or other non-optical imaging techniques. Using any of these forensics techniques, however, disrupts or destroys the latent material; hence, the fingerprint is lost from being available for further examination at a location other than where the fingerprint is found. In a similar manner, when suspicious fluids (including bodily fluids), which may also be classified as latent material, are found, collection methods may result in the destruction of the fluid.

One technique has been developed where the latent material is not disrupted involves taking a photograph of the latent material where there is sufficient clarity to view the ridges in a fingerprint in the photograph. Such techniques would be most beneficial if the cost of equipment to illuminate is reasonable, especially in view of the costs associated with current identification processes. One aspect to provide reasonably priced imaging system is to provide a reasonably priced illumination system.

FIG. 1 discloses a prior art representation of a cross section view of a flash lamp as a light source for use with an imaging system. When illuminated, there is a buildup of plasma 12 within the flash lamp 10, which burns to create a light, or photons. The plasma 12 has height, width, and depth on the order of a millimeter in each direction. The flash lamp 10 has a reflector 14 behind the plasma 12, such as a parabolic reflector 14 behind the plasma 12 to reflect the backward propagating photons, or light rays (or light), towards an output 16, or opening. The output 16 is opposite the parabolic reflector 14. The parabolic reflector 14 has a focal length only a few times larger than the size of the plasma 12. This prevents the flash lamp 10 from producing a truly collimated beam of light. Some of the photons from the plasma reflect off the parabolic reflector 14 and propagate out in somewhat of a beam configuration. Whereas, other photons miss the reflector altogether and propagate out of an output of the flash lamp 10 in a plurality of different directions. Each of the rays of light, or photons, comprises every wavelength which the flash lamp 10 may produce, such as, but not limited to, ranging from an ultraviolet (U-VC) to a long wave wavelength.

FIG. 2 illustrates a prior art representation of photon paths at an extended distance from the flash lamp. As the photons move further away from the flash lamp 10, propagation of the photons continues to expand to where a beam of light is less defined. As illustrated in both FIGS. 1 and 2, the flash lamp 10 alone does not provide a light which is acceptable for illuminating latent material where indents in the material would be visible. This is due, in part, to having all wavelengths comprising the light impinging upon the latent material. One approach previously applied to better focus a light beam involved using lenses.

FIG. 3 illustrates a prior art representation where a lens (a transmissive component) is placed at the output of the flash lamp. Though some of the light comes to a focus, as a more defined beam, after passing through the lens 18, as the photons move further way from the lens 18, the light propagates to where the light beam is less distinct as the photons move further away from the flash lamp 10. Thus, if the lens 18 is located at the output of the flash lamp 10, scattering of the photons may result in the flash lamp 10 being less effective for its intended purpose, such as, but not limited to, being a light source 10 to illuminate latent material.

Entities seeking to collect images of latent material would benefit from a system and method where latent images may be collected from latent material where enough clarity is available from an illumination system to determine characteristics about the latent material, such as, but not limited to, fingerprint ridge patterns, without disturbing a location where the latent material is found.

### SUMMARY

Embodiments relate to a system and a method for controlling scattered light in a reflective optical filter. The system comprises a housing configured to receive a light emitted from an illumination source, and a reflective filter system within the housing configured to direct a certain wavelength of the light emitted from the illumination source towards a target. The system further comprises a baffle system configured to remove scattered light from the light emitted from the illumination source prior to the certain wavelength of light illuminating the target.

The method comprises illuminating a light within housing before the light reaches a target, and filtering the light through a reflective filtering system in the housing to direct a certain wavelength of the light towards the target. The method also comprises removing scattered light from the light prior to the certain wavelength of light reaching the target with a baffle system, and illuminating the target with the light passed through the filtering system and baffle system.

Another embodiment of the system comprises an illuminating source, an imaging device, and a housing configured to receive a light generated by the illuminating source. The system also comprises a reflective filter system configured to direct a certain wavelength of the light towards a target, and a baffle system configured to remove scattered light from the light prior to the certain wavelength of light illuminating a target. The imaging device captures an image of the target when illuminated by the light with the certain wavelength.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 discloses a prior art representation of a cross section view of a flash lamp as a light source for an imaging system;

FIG. 2 illustrates a prior art representation of photon paths at an extended distance from the flash lamp;

FIG. 3 illustrates a prior art representation where a lens is placed at the output of the flash lamp;

FIG. 4 shows an embodiment of a block diagram of a system for imaging latent material;

FIG. 5 shows an embodiment of a reflective filter system for producing a desired light frequency;

FIG. 6 Shows an embodiment of a system for controlling scattered light;

FIG. 7 shows an embodiment of an unfolded optical with a baffle system;

FIG. 8 shows an image of an image taken with an earlier version of an embodiment;

FIG. 9 shows an white image of an image taken with an earlier version of an embodiment;

FIG. 10 shows an image of an image taken with an embodiment;

FIG. 11 shows an image of an image taken with an embodiment; and

FIG. 12 shows a flowchart illustrating a method for controlling scattered light.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

As disclosed in further detail below, certain imaging applications may use a filtered flash lamp to illuminate a sample, or target, so it can be photographed. It is possible to have an optical filter that uses reflective components (a reflective filter system) rather than transmissive components. The inventor has learned that the reflective filter system is much more efficient than a transmissive filter. All of the photons, or light, coming from the flash lamp may be reflected off optical components (such as, but not limited to, mirrors) in order to be filtered. Any light that gets through the filter without reflecting off the optical components acts as noise (scattered light) on the sample being illuminated. The embodiments described herein reduce an amount of noise (scattered light) on the sample by controlling the scattered light inside a housing.

As used herein, though the term “flash lamp” is used, other terms such as, but not limited to, lamp, light source, illuminating source, etc., may also be used. Similarly, though the term “light” is used, other terms such as, but not limited to, photons, light beam, etc., may be used. Additionally, though “imaging device” is disclosed, other terms, such as, but not limited to, camera imaging system, etc., may be used.

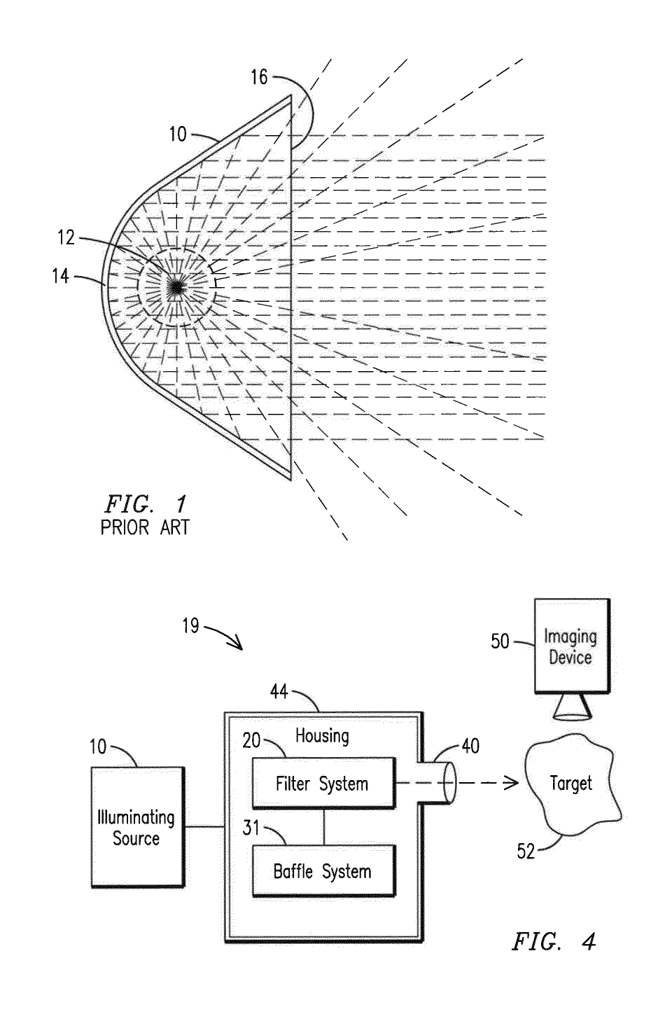

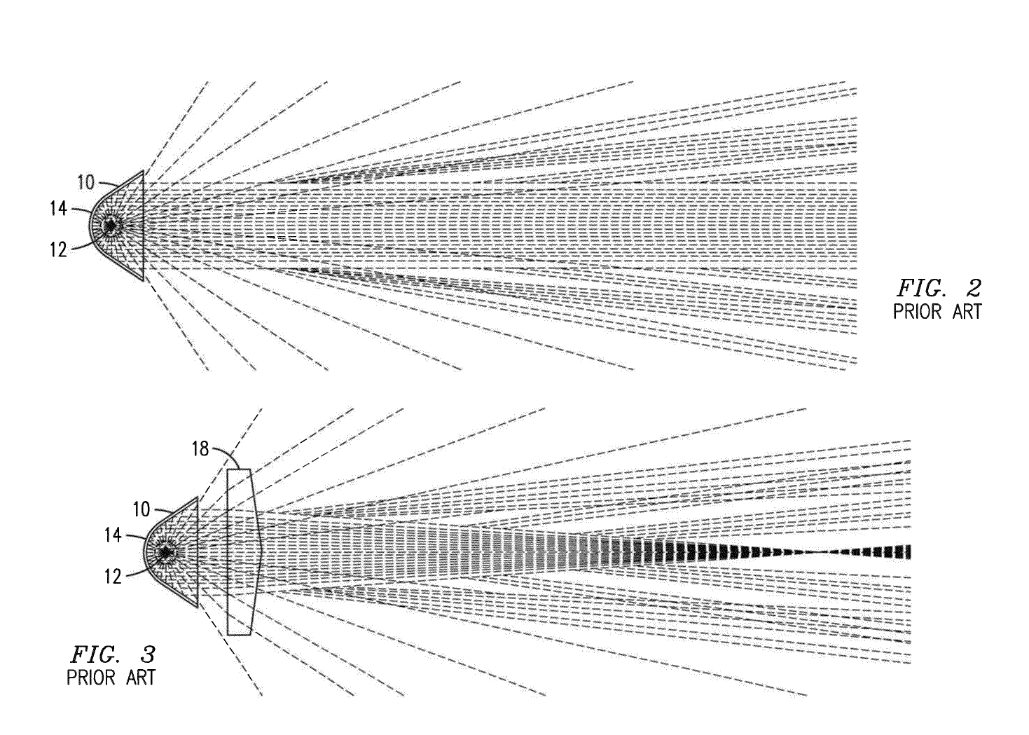

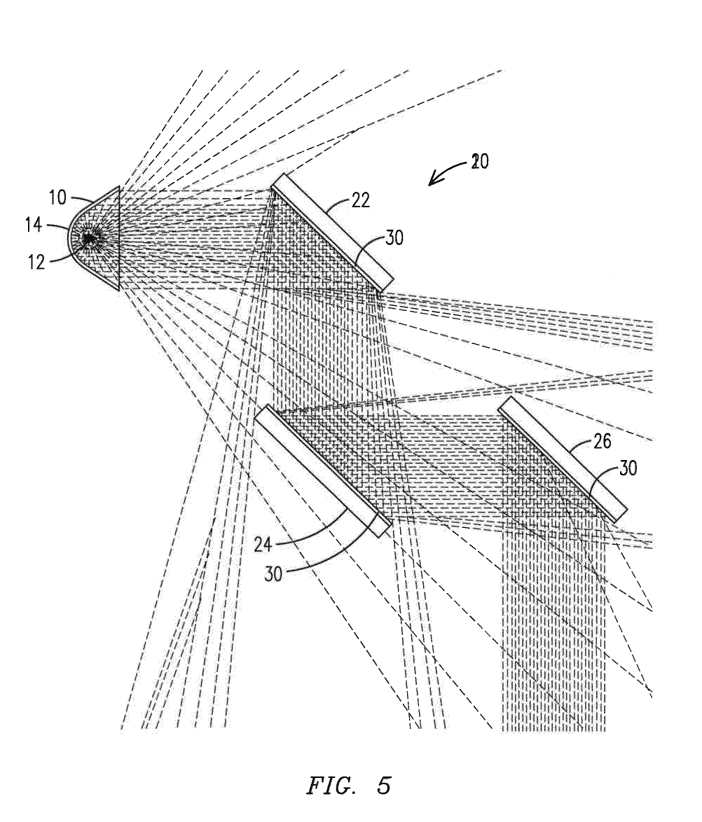

FIG. 4 shows an embodiment of a block diagram illustrating a system for producing a desired illuminated light frequency at a target. The system 19 may have an illuminating source 10. An imaging device 50 is also provided. The illuminating source 10 provides a light to illuminate a target 52 and the imaging device 50 captures a picture of the illuminated target 52. Before the light reaches the target 52; however, to be available when the imaging device 50 is used to take a picture of the target 52, the light passes through a housing 44 where it interacts with a filter system 20 and a baffle system 31. The filter system 20 may direct a certain wavelength of the light towards the target 52, through an aperture 40, whereas the baffle system 31 may block or remove scattered light (noise) from the light at the certain wavelength. More particularly, scattered light divergent from the light is blocked from passing through the aperture.

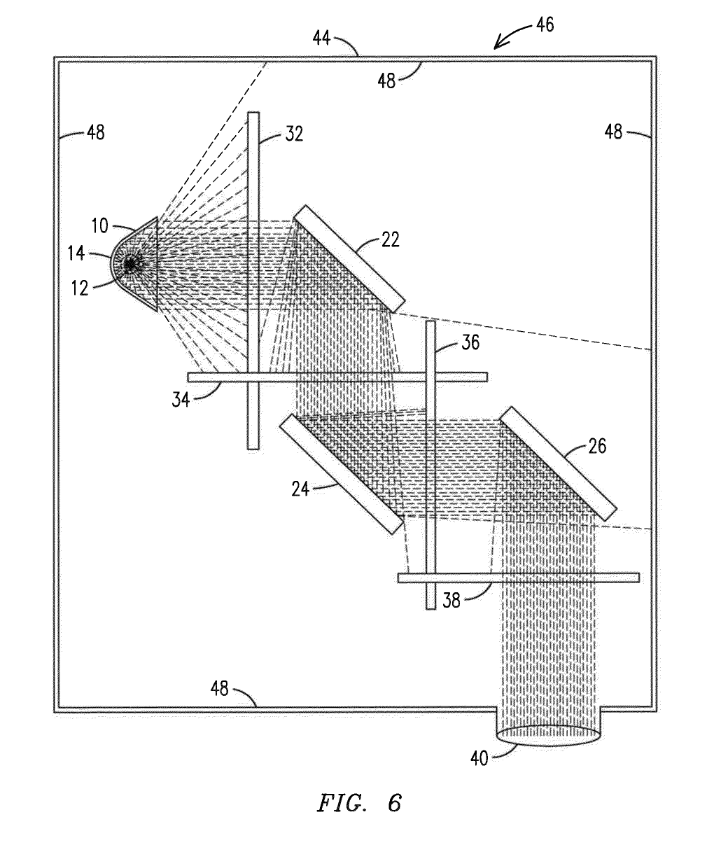

FIG. 5 shows the light interacting with the filtering system 20. The light radiates from the flash lamp 10 and reflects off of a plurality of mirrors 22, 24, 26. Though three mirrors 22, 24, 26, or reflective surfaces, are disclosed, any plurality of mirrors may be used. The mirrors 22, 24, 26 are used to filter the light to a state needed by the imaging device 50. The mirrors 22, 24, 26 are positioned to capture reflected light from an immediate prior placed mirror, or when considering a first mirror 22, then after the flash lamp 10 emits the light. More specifically, light emitted from the lamp 10 is reflected in a sequence from a first reflective surface of a plurality of reflective surfaces to a last reflective surface of the plurality of reflective surfaces prior to illuminating a target. As illustrated, any light that misses the mirrors 22, 24, 26 is not filtered and considered noise or scattered light. Thus, the mirrors 22, 24, 26 are positioned to capture a sufficient amount of the light in a beam formation so that a sufficient amount is available for the imaging device 50.

Each mirror 22, 24, 26, including the reflector 14 in the flash lamp 10, may comprise a coating 30 to allow only a certain frequency of light to reflect off of each coated mirror 22, 24, 26 or reflector 14. As a non-limiting example, the coating may only allow ultraviolet (U-VC) light to be reflected. Though it may be coated, typically, when applying embodiments to existing flash lamps, the reflector behind the plasma in the flash lamp is typically designed to reflect as many wavelengths as possible. Thus, as light or photons emitted from the flash lamp 10 propagates through the reflective filter system 20, the photons missing the optical surfaces 22, 24, 26 are referred to as scattered light/photons or noise. Because of these features, the mirrors or reflective surfaces 22, 24, 26 may also assist with the removal of the scattered light.

Depending on a type of bodily fluid seeking to be detected, such as bodily fluid typically associated with fingerprints, the coating 30 may have an optimum wavelength range. The range will depend on the fluid itself and the surface it's residing upon. In the illustrations discussed herein, the range for the coating used was less than 200 nm, though an optimum value of about 195 nm may be used to image latent fingerprints on ordinary paper.

FIG. 6 shows an embodiment of a system for controlling scattered light. The system 46 may typically be contained within a housing 44. The housing walls 48, or inner surface, may diffusely reflect and partially absorb any light that hits them. Thus, the inner surface 48 of the housing 44 may be black in color so as to act as close as possible to a black body. While some of the scattered light may be absorbed by the inner walls 48 of the housing 44, some will scatter off the housing walls 48 and may eventually reach the target 52 and degrade the image taken by the imaging device 50. But due to the embodiments disclosed herein, such degradation is minimized when compared to not employing the embodiments described herein.

Though FIG. 6 shows the flash lamp 10 being within the housing 44, the flash lamp 10 may be located outside of the housing 44. When located outside the housing 44, a baffle 32 of the baffle system 31 may be located on the housing 44 at an aperture, a receiving aperture, where photons emitted from the flash lamp 10 may enter the housing 44. As used herein, having the housing 44 to receive the light generated by the illuminating source 10 may comprise either the illuminating source 10 being within the housing 44 or outside of the housing 44 with the light being directed into the housing 44. This is because in either situation, the light is still actually received within the housing 44. An aperture 40 is provided through which the light, having passed through the filter system 20 and baffle system 31, leaves, or exits, the housing 44 to illuminate the target 52.

Typically, there are three classes of photons passing within an embodiment of a system 46. A first class of photons may be considered unfiltered as they will hit the housing walls 48 without encountering the mirrors 22, 24, 26. A second class of photons may be considered partially filtered as they will reflect off some or all of the mirrors 22, 24, 26 and also hit the housing walls 48. A third class of photons may be considered fully filtered as they will reflect off all the mirrors 22, 24, 26 without hitting any other surfaces. Thus, it is intended that only the fully filtered photons are allowed to reach the target 52, whereas the unfiltered and partially filtered photons are effectively blocked, or prevented from reaching the target 52. However, some of the unfiltered and partially filtered photons will still reach the target since the inventor realizes that not all of these unwanted photons will be blocked.

As briefly mentioned above and further disclosed in FIG. 6, the baffle system 31 is also provided. The baffle system 31 comprises a plurality of baffles 32, 34, 36, 38. By arranging the baffles 32, 34, 36, 38 having specific shapes (or each having a particular shape) at particular locations within the photon (light) beam path inside the housing 44, it is possible to control and at least partially absorb scattered light within the housing 44. In some variations, the baffles 32, 34, 36, 38 may also shape the light beam so that it has the same aspect ratio as the field of view (“FOV”) of a camera or imaging device 50 used to photograph an illuminated target/sample.

Each respective baffle 32, 34, 36, 38 is a mechanical system, vane, wall, etc., whose function is to shield the light coming from the illuminating source outside the FOV of the imaging device. As illustrated, the light outside the angular view of the imaging device 50 may be configured to execute multiple numbers of reflections to minimize an intensity of the light that eventually reaches the illuminated target 52.

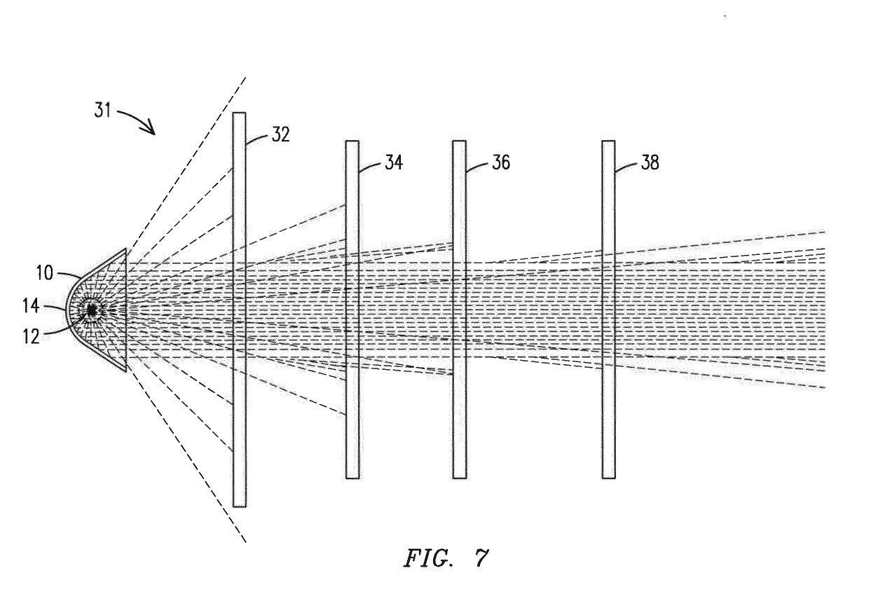

FIG. 7 shows an embodiment of an unfolded optical filter with a baffle system. The illustration in FIG. 7 demonstrates that baffles 32, 34, 36, 38 may be used to control scattered light inside the housing 44. The baffles 32, 34, 36, 38 are sized and placed such that photons going straight to the target from the flash lamp 10 are not obstructed, but any other photons are blocked. If the optical path provided for the photons within the housing 44 is unfolded about the reflective surfaces, the operation of the baffles 32, 34, 36, 38 is more easily seen, namely, once the beam is unfolded about a mirror surface, the mirror components are removed.

The unfolded system illustrated in FIG. 7 would have a reflective surface or mirror between each baffle 32, 34, 36, 38. More specifically, one baffle is placed between each reflective surface and one additional baffle is added after the last reflective surface. The holes, or apertures, in each baffle are sized so that photons passing directly from the flash lamp 10, reflecting off the reflective surfaces, and falling within a defined illumination foot print on the target are allowed to pass through. If the lamp 10 is located outside of the housing, a baffle may be located outside of the housing 44, surrounding the aperture through which the photons from the lamp 10 pass through and into the housing 44.

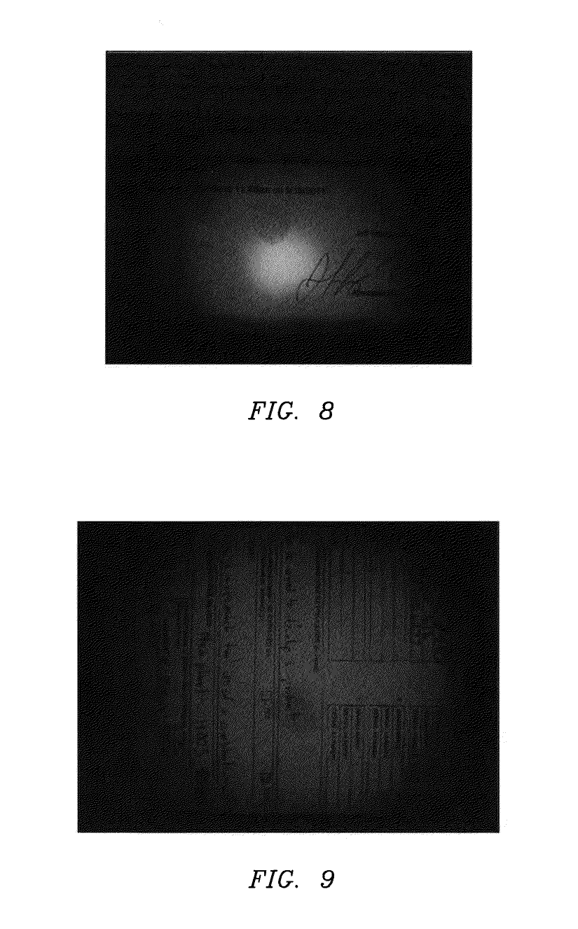

Several systems were constructed and tested by the inventor. Typical results are as follows. The inventor learned that an improvement to an optical filter based on using reflection coatings was realized. An early development by the inventor used a band pass filter followed by two 90 degree turning prisms used in external reflection, each with a maximum reflection (Rmax) coating at 45 degrees at 193 nm on the hypotenuse of each prism. The assembly was placed in a small housing and produced an illumination typical of that seen in FIG. 8.

As further illustrated in FIG. 8, a bright spot (Hot Spot) is in the image. Even though nothing on the paper in the image should be visible, but one shade of fluorescence (blue in color) from the paper, a white light and several shades of blue are also visible. Furthermore, all the print at the top of the image should not be visible, but is because of non-filtered white light hitting the paper. The usable portion of this image (for collecting latent fingerprints) is only the blue portion near the central part of the image where two fingerprints are visible, The usable portion of the image is much smaller than the camera FOV.

Though results are not illustrated, in a follow up development effort by the inventor, a plastic housing was used to hold the flash lamp and three pieces of filter glass at 45 degrees to the optical axis. Each filter has a neutral density (ND) of 1 and has an Rmax coating at 193 nm. There were no baffles in the housing. The resulting light output illuminated the paper samples better than the above system (larger illumination, more uniform), but it was less sensitive than the above system, i.e., it did not see the fingerprints as well.

Next the inventor applied a plastic housing with circular baffles between each optic and after the last optic was used with the same ND filter glass. A typical result is given below with respect to FIG. 9. The hot spot is not so prominent, the white light (noise) is much less visible, and the sensitivity to fingerprints is improved. Without the lens or diffuser, the illumination spot was much smaller than the FOV of the camera. A negative 50 mm lens at the output spread the illuminating light better than a diffuser. The image in FIG, 9 shows that the illumination (with a −50 mm lens) is about the same size as the camera FOV.

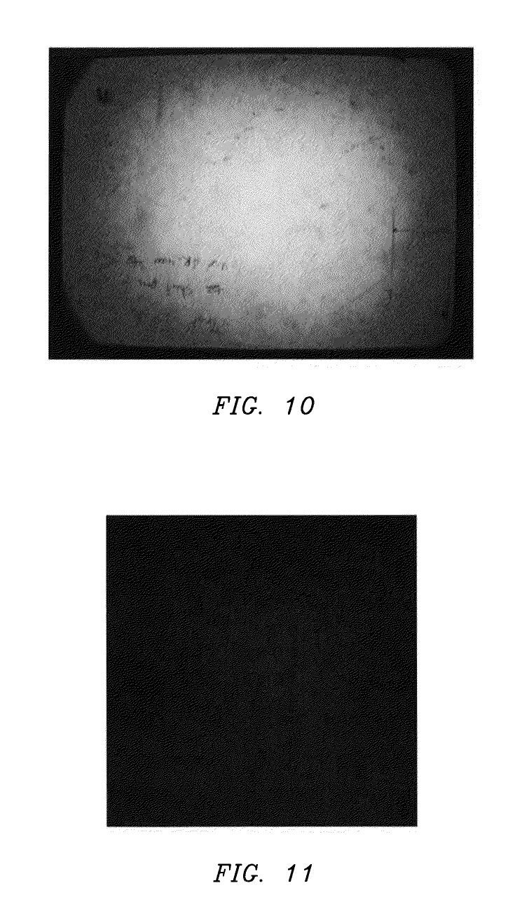

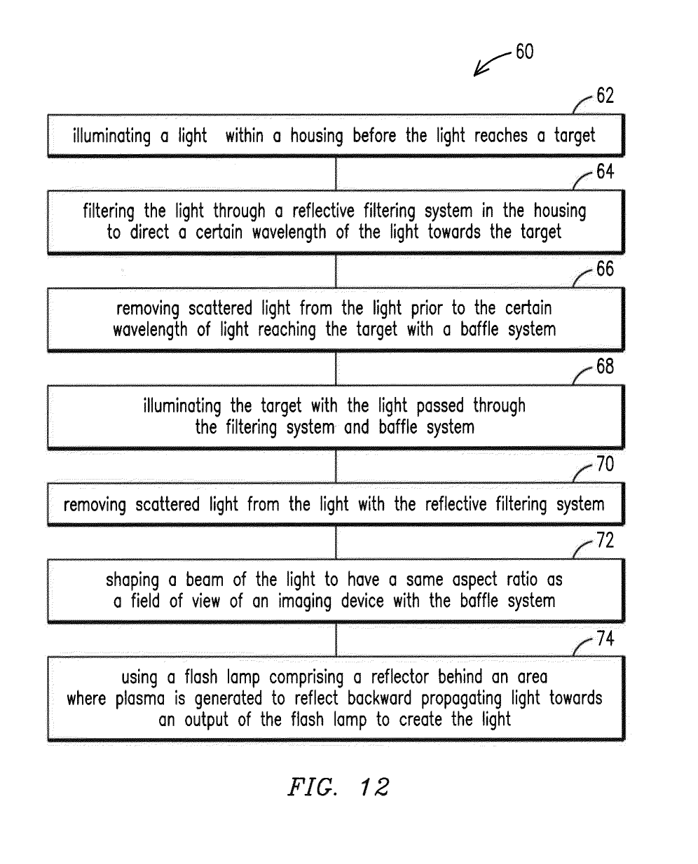

Making the baffles square, or having a quadrilateral shape, instead of round, or generally circular shape, made the illumination square (such as rectangular) as well. Following are two images, FIGS. 10 and 11 which were taken using the filter housing with rectangular baffles.

The image in FIG. 10 is over exposed to show the size of the hot spot. Most of the camera FOV is illuminated. A left side of the image, a top and bottom corners are each rounded. This rounded illustration is because the rectangular baffle is actually larger than the negative lens used to spread the light over the sample and clips the light. Though not visible in a black and white image, the entire sample is only one color of blue.

FIG. 11 shows an image using an embodiment disclosed herein with fingerprints visible. The baffles inhibit the unfiltered light in the housing from reaching the sample thus increasing the sensitivity of the system.

FIG. 12 shows a flowchart illustrating a method for controlling scattered light. The method 60 comprises illuminating a light within a housing before the light reaches a target, at 62, and filtering the light through a reflective filtering system in the housing to direct a certain wavelength of the light towards the target, at 64. The method 60 further comprises removing scattered light from the light prior to the certain wavelength of light reaching the target with a baffle system, at 66, and illuminating the target with the light passed through the filtering system and baffle system, at 68.

The method may further comprise removing scattered light from the light with the reflective filtering system, at 70. The method may also comprise shaping a beam of the light to have a same aspect ratio as a field of view of an imaging device with the baffle system, at 72. The method may also comprise using a flash lamp comprising a reflector behind an area where plasma is generated to reflect backward propagating light towards an output of the flash lamp to create the light, at 74. In an embodiment, the reflector may be a parabolic reflector. In an embodiment, the reflector may comprise a coating to reflect a certain wavelength of the light towards the output of the flash lamp to create the light, at 74.

Filtering the light through the reflective filtering system, at 64, may further comprise reflecting the light through a series of mirrors configured to allow the light to travel from a first mirror in the series to a next mirror in the series until reaching a last mirror in the series, at least one mirror of the series of mirrors comprises a coating to reflect a certain wavelength of the light as the light passes through the series of mirrors.

By applying the method and/or using the embodiments disclosed herein, the latent fingerprint does not need to be disturbed since sufficient light is provided to take an image of the latent fingerprint. Thus, there is no need to apply dusting, super-glue fuming, and/or other non-optical imaging techniques which result in material coming into direct contact with the latent image.

While embodiments have been described with reference to various embodiments, it will be understood by those skilled in the art that various changes, omissions and/or additions may be made and equivalents may be substituted for elements thereof without departing from the spirit and scope of the embodiments. In addition, many modifications may be made to adapt a particular situation or material to the teachings of the embodiments without departing from the scope thereof. Therefore, it is intended that the embodiments not be limited to the particular embodiment disclosed as the best mode contemplated, but that all embodiments falling within the scope of the appended claims are considered. Moreover, unless specifically stated, any use of the terms first, second, etc., does not denote any order or importance, but rather the terms first, second, etc., are used to distinguish one element from another.

I claim:

1. A system comprising:
a housing configured to receive a light emitted from an illumination source;
a reflective filter system within the housing configured to direct a certain wavelength of the light emitted from the illumination source towards a target; and
a baffle system configured to remove scattered light from the light emitted from the illumination source prior to the certain wavelength of light illuminating the target.

2. The system according to claim 1, further comprising an aperture through which the light, having passed through the filter system and baffle system, leaves the housing to illuminate the target.

3. The system according to claim 1, wherein the reflective filter system is further configured to remove scattered light from the light emitted from the illumination source.

4. The system according to claim 1, wherein the reflective filter system comprises a plurality of reflective surfaces, each reflective surface further comprising a coating configured to reflect the certain wavelength of the light emitted from the illumination source.

5. The system according to claim 4, wherein the plurality of reflective surfaces are configured within the housing to reflect the light emitted from the illumination source in a sequence from a first reflective surface of the plurality of reflective surfaces to a last reflective surface of the plurality of reflective surfaces prior to illuminating the target.

6. The system according to claim 1, wherein the baffle system comprises a plurality of baffles, each individual baffle comprising an aperture through which the light emitted may pass through the aperture while scattered light divergent from the light is blocked from passing through the aperture.

7. The system according to claim 6, wherein at least one baffle of the plurality of baffles comprises a same aspect ratio as an imaging device used with the system.

8. The system according to claim 6, wherein at least one baffle of the plurality of baffles comprises a particular shape.

9. The system according to claim 8, wherein the particular shape is a quadrilateral or is generally circular.

10. The system according to claim 4, wherein the baffle system comprises a plurality of baffles and at least one baffle of the plurality of baffles is at location with respect to at least one reflective surface to reduce scattered light from reaching the target.

11. A method comprising:
illuminating a light within housing before the light reaches a target;
filtering the light through a reflective filtering system in the housing to direct a certain wavelength of the light towards the target;
removing scattered light from the light prior to the certain wavelength of light reaching the target with a baffle system; and
illuminating the target with the light passed through the filtering system and baffle system.

12. The method according to claim 11, wherein filtering the light through the reflective filtering system further comprises reflecting the light through a series of reflective surfaces configured to allow the light to travel from a first reflective surface in the series to a next reflective surface in the series until reaching a last reflective surface in the series, at least one reflective surface of the series of mirrors comprises a coating to reflect a certain wavelength of the light as the light passes through the series of reflective surfaces.

13. The method according to claim 11, further comprising removing scattered light from the light with the reflective filtering system.

14. The method according to claim 11, further comprising shaping a beam of the light to have a same aspect ratio as a field of view of an imaging device with the baffle system.

15. The method according to claim 11, further comprising using a flash lamp comprising a reflector behind an area where plasma is generated to reflect backward propagating light towards an output of the flash lamp to create the light.

16. A system comprising:
an illuminating source;
an imaging device;
a housing configured to receive a light generated by the illuminating source;
a reflective filter system configured to direct a certain wavelength of the light towards a target; and
a baffle system configured to remove scattered light from the light prior to the certain wavelength of light illuminating a target;
wherein the imaging device captures an image of the target when illuminated by the light with the certain wavelength.

17. The system according to claim 16, wherein the illuminating source comprises a parabolic reflector located opposite an opening, through which the light exits the illuminating source, the parabolic reflector is configured to reflect a certain wavelength of the light towards the opening.

18. The system according to claim 16, wherein the reflective filter system comprises a plurality of reflective surfaces, each reflective surface is configured to reflect the certain wavelength of the light emitted from the illumination source.

19. The system according to claim 16, wherein the baffle system comprises a plurality of baffles, each individual baffle comprising an aperture through which the certain wavelength of the light emitted may pass through the aperture while scattered light divergent from the light is blocked from passing through the aperture.

20. The system according to claim 19, wherein the aperture of each individual baffle comprises a same aspect ratio as the imaging device.
